(19) United States
(12) Patent Application Publication
(10) Pub. No.: US 2014/0040988 A1
(43) Pub. Date: Feb. 6, 2014

(54) Method and System for Data Communication to an Identification Module in a Mobile Radio Terminal

(71) Applicants: Thorsten Nozulak, Oer-Erkenschwick (DE); Ulrich Seifert, Dusseldorf (DE); Elmar Johnen, Koln (DE)

(72) Inventors: Thorsten Nozulak, Oer-Erkenschwick (DE); Ulrich Seifert, Dusseldorf (DE); Elmar Johnen, Koln (DE)

(73) Assignee: VODAFONE HOLDING GMBH, Dusseldorf (DE)

(21) Appl. No.: 14/111,754

(22) PCT Filed: Apr. 12, 2012
(86) PCT No.: PCT/EP12/56608

§ 371 Date: Oct. 14, 2013

(30) Foreign Application Priority Data
Apr. 15, 2011 (DE) 10 2011 007 534.8

(51) Int. Cl. H04W 12/06

(52) U.S. Cl. CPC H04W 12/06
USPC 726/3

(57) ABSTRACT

The technique described herein relates to a method for transmitting data to an identification module in a mobile terminal device that can be connected to a mobile telecommunications network, making use of an OTA server that has a database with security information for a plurality of identification modules and that also has a first interface for transmitting secured information, especially OTA messages, to the identification modules. The data is secured in the OTA server by security information stored in the database, and the secured data is transferred via a second interface of the OTA server to a data center that is connected to the OTA server. The data is transmitted to the identification module by the data center. Moreover, the technique described herein also relates to a system for carrying out the method.

### CROSS-REFERENCE TO RELATED APPLICATIONS

Pursuant to 35 U.S.C. §371, this application is the United States National Stage Application of International Patent Application No. PCT/EP2012/056608, filed on Apr. 12, 2012, the contents of which are incorporated by reference as if set forth in their entirety herein, which claims priority to German (DE) Patent Application No. 10 2011 007 534.8, filed Apr. 15, 2011, the contents of which are incorporated by reference as if set forth in their entirety herein.

### BACKGROUND

Mobile terminal devices are normally operated in conjunction with identification modules that contain processes and information to identify and authenticate a subscriber or a subscription of the subscriber in a mobile telecommunications network during the log-on to a mobile telecommunications network. For this purpose, the identification modules contain algorithms and subscription data that are protected by the security features of the identification module against unauthorized access. Moreover, user data, for instance, received and sent messages as well as address book data, can be stored in the identification modules. Thanks to their security features, identification modules are also suitable for storing sensitive data of the user and for executing sensitive applications that can be used, for example, to carry out cryptographic processes or security-critical transactions, such as, for instance, payment transactions.

Normally, the identification modules are configured as chip cards that can be removably inserted into mobile terminal devices. Examples of such identification modules are SIM (Subscriber Identity Module) and USIM (Universal Subscriber Identity Module) cards, which are used in systems such as GSM (Global System for Mobile Communications) and UMTS (Universal Mobile Telecommunications System), especially for subscriber identification and authentication.

Many identification modules support remote access, especially via the mobile telecommunications network, by which modifications can be made to the identification modules, or else functions of the identification modules can be controlled, without having to take the identification modules to a service center or even having to replace them. Modifications can comprise, for example, the storage or manipulation of data and the installation of applications in the identification module. In order for such remote access to be carried out securely, the so-called OTA (Over the Air) mechanism is available, which was specified by the ETSI (European Telecommunications Standard Institute) or by the 3GPP (3rd Generation Partnership Project), in various versions in the standard documents GSM 03.48, TS 23.048 as well as TS 102 225, TS 102 226, TS 31.114 and TS 31.115. Implementations of the OTA mechanism normally provide that an OTA server sends information to the identification modules that is encrypted with secret cryptographic keys that are unambiguously associated with the identification modules and that are stored in a database of the OTA server. The encryption ensures that remote access is not possible for unauthorized third parties, and that information addressed to a specific identification module is protected against unauthorized access along the transmission route.

As a rule, the information is sent to the identification modules by an OTA server in so-called OTA messages that are often transmitted by SMS (Short Message Service). For this purpose, the OTA server is connected via an interface to an SMSC (Short Message Service Center) through which the OTA messages are sent. The OTA messages are received in the mobile terminal device in which the addressed identification module is situated and they are transferred to the identification module inside the mobile terminal device. As a rule, this is done transparently, that is to say, invisibly to the user of the mobile terminal device.

In this embodiment of the OTA mechanism, however, the problem exists that the size of the OTA messages that can be transmitted by the SMS is limited. Thus, SMS messages have a maximum data content of 160 characters when the widespread 7-bit encoding is used. OTA information whose data volume exceeds the maximum size of an SMS message can fundamentally nevertheless be transmitted if it is split into several OTA messages from which the identification module then once again recombines the information (so-called concatenated SMS messages). However, it has been found that transmission errors often occur here, especially due to faulty concatenation of the total information from the individual pieces of information contained in the various messages.

U.S. Application No. 2005/0021937 A1 discloses a system that has a first communication device and a second communication device. The first communication device is configured in such a way that it can exchange a message with the first communication protocol via a network using a first communication protocol. This message is adapted to a second communication protocol and the second communication device is configured in such a way that it can transmit the message by the second communication protocol to a third communication device, which can understand this second communication protocol.

International patent application WO 2008/035183 A2 discloses a method and a system for transmitting data from a server to at least one mobile station. For this purpose, the server sends a notification to the mobile station informing the mobile station that data is available that can be transmitted to the mobile station. The mobile station then sends a request to the server to transmit the data from the server to the mobile station. In response to the request, the server sends the data that is to be transmitted.

European patent application EP 2 106 191 A1 discloses a method for updating a smartcard and it also discloses such a smartcard.

### SUMMARY

The technique described herein relates to the transmission of data to an identification module of a mobile terminal device. In particular, the technique described herein relates to a method and to a system for transmitting data to an identification module in a mobile terminal device that can be connected to a mobile telecommunications network, making use of an OTA (Over the Air) server.

Before this backdrop, it is the objective of the techniques described herein to allow OTA information with a high data volume to be more reliably transmitted to the identification module.

According to a first aspect of the techniques described herein, a method is proposed for transmitting data to an identification module in a mobile terminal device that can be connected to a mobile telecommunications network making use of an OTA server. The OTA server has a database with security information for a plurality of identification modules, and it also has a first interface for transmitting secured information, especially OTA messages, to the identification modules. In the method, the data is secured in the OTA server via security information stored in the database, and the secured data is transferred via a second interface of the OTA server to a data center that is connected to the OTA server. The data is transmitted to the identification module by the data center.

According to another aspect of the technique described herein, a system is proposed for transmitting data to an identification module in a mobile terminal device that can be connected to a mobile telecommunications network. The system comprises an OTA server that has a database with security information for a plurality of identification modules, and it also has a first interface for transmitting secured information, especially OTA messages, to the identification modules. Moreover, the system comprises a data center that provides the data for the transmission to the identification module. The OTA server is configured to secure the data and to transfer it to the data center via a second interface of the OTA server so as to make it available for the transmission.

In order to be secured, the data to be transmitted to the identification module is transferred by the data center to the OTA server via the second interface. The data center accesses the OTA server in order to secure the data. Moreover, the data is made available for the transmission to the identification module.

In the method and in the system, the data is secured in the OTA server, but it is not transmitted by the OTA server to the identification but rather by a data center that can use data transmission channels that differ from those used by the OTA server. In particular, the data center is not restricted to the transmission of messages with a limited data volume. As a result, large data volumes can also be reliably transmitted to the identification modules. The security against unauthorized access is ensured in that the OTA server is used to secure the data that is to be transmitted. In this process, the security features do not leave the OTA server, as a result of which fraudulent access to the security features can be prevented.

The data transmitted to the identification module can especially be parameters, programs or other information to be installed in the identification module and/or control commands that are to be executed in the identification module. The security information that is stored in the database of the OTA server for a plurality of identification modules and that is used to secure the data to be transmitted to the identification modules comprises cryptographic keys. The data is, in embodiments, secured by an at least partial encryption with a cryptographic key. The cryptographic keys can each be unambiguously associated with the identification modules.

A related embodiment of the method and of the system provides that, in order to specify the security information to be used, the data center transfers to the OTA server an identifier associated with the identification module, whereby the security information is stored in the database along with an indication of the identifier. The identifier, together with the data to be secured, can be transferred by the data center to the OTA server via the second interface. The identifier can especially be a telephone number that is configured as an MSISDN (Mobile Subscriber Integrated Services Digital Network Number) and that is associated with the identification module. As a rule, this telephone number is also used by the OTA server for addressing OTA messages and consequently, it is stored in the database of the OTA server, together with security information of the identification module. As an alternative or in addition to this, other identifiers associated with the user can also be used.

In a refinement of the method and of the system, the transmission of the data to the identification module is effectuated in that the data is retrieved from the data center by the mobile terminal device. In one embodiment of the method and of the system, the retrieval of the data from the data center by the mobile terminal device is controlled by the identification module. An advantage of the retrieval of the data is that the transmission is initiated by the mobile terminal device or by the identification module contained in it, so that the transmission takes place at a point in time at which the mobile terminal device is switched on and connected to a mobile telecommunications network. Repeated transmission attempts because an identification module is not available can be avoided in this manner.

One embodiment of the method and of the system entails that the data is retrieved from the data center in response to a message being received in the mobile terminal device, especially in the identification module. On the basis of the message, the identification module can be informed that data is available in the data center for retrieval. A refinement of the method and of the system is characterized in that the data is made available for retrieval under an address, especially a URL (Uniform Resource Locator), and in that the address is contained in the message. Under such an address, the identification module can retrieve and download the data, making use of a data service of the data center that is provided by the mobile telecommunications network.

In another embodiment of the method and of the identification module, the message is sent by the OTA server and it is an OTA message. Advantageously, in this embodiment, the already established, secure OTA mechanism is utilized to transmit to the identification module the message that informs the identification module about the availability of data in the data center and that instructs the identification module to retrieve the data. Another embodiment of the method and of the system is characterized in that the data center instructs the OTA server to transmit the OTA message to the identification module.

In one embodiment of the method and of the system, the identification module is a secure module in the mobile terminal device that provides information and/or processes for identifying and/or authenticating the identification module in the mobile telecommunications network. The module can be configured as a chip. In one embodiment, the chip can be a component of a chip card that has been placed into the mobile terminal device. In particular, this can be a SIM card or a USIM card. By the same token, however, it can also be provided that the identification module is configured as a software module that is executed in a processor of the mobile terminal device and that is also responsible for other tasks. In particular, this can be a main processor of the mobile terminal device.

The above-mentioned and additional advantages, special features and practical refinements of the technique described herein are also explained on the basis of the embodiments that will be described below with reference to the figures.

### BRIEF DESCRIPTION OF THE DRAWINGS

FIG. 1 is a schematic view of a mobile telecommunications network having an OTA server and a data center as well as a mobile terminal device connected to the mobile telecommunications network, and

FIG. 2 is a schematic flow chart for illustrating the secure transmission of data to an identification module of the mobile terminal device.

### DETAILED DESCRIPTION OF SPECIFIC EMBODIMENTS

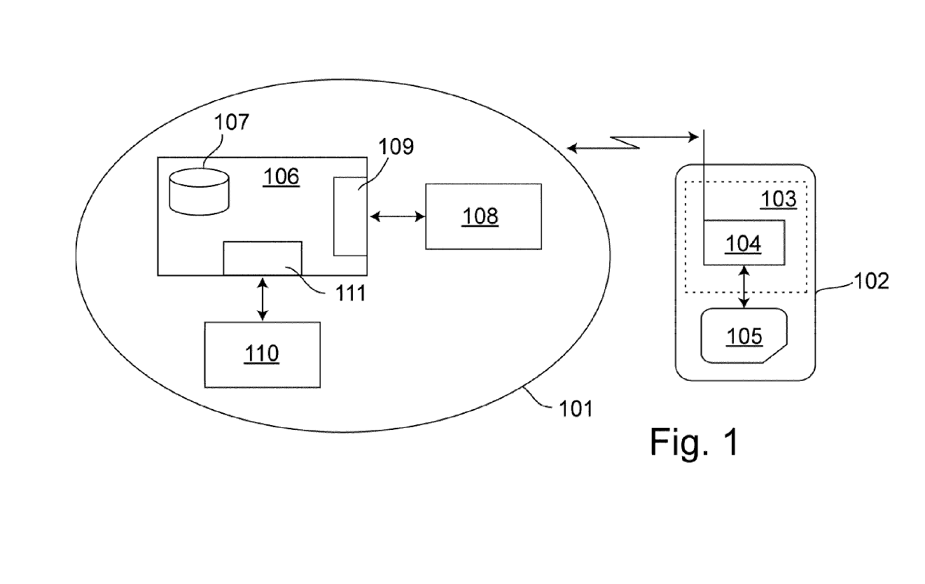

FIG. 1 schematically shows a mobile telecommunications network 101 to which mobile terminal devices 102 can be connected wirelessly via an access network (not shown in the figure) in order to make use of mobile telecommunications services provided by the mobile telecommunications network 101 such as, for example, voice, data and message transmission. By way of an example, FIG. 1 shows a mobile terminal device 102 of a mobile telecommunications subscriber that has an identification module 105 to which data can be transmitted via the mobile telecommunications network 101.

The mobile terminal device 102 is an electronic communication device that can be configured as a mobile or stationary terminal device. In one embodiment, the mobile terminal device 102 is employed by a user to access services provided via the mobile telecommunications network 101, for which purpose suitable user interfaces, especially suitable input and output devices, are provided. Examples of services that can be provided via the mobile telecommunications network 101 and that can be used by the mobile terminal device 102 include services for voice or video calls, data services or services for access to data networks such as the Internet, as well as message services such as SMS, MMS (Multimedia Messaging Service) or e-mail. In this embodiment, the mobile terminal device 102 can be, for example, a mobile phone, a smart phone, a tablet, a notebook computer or the like. By the same token, the mobile terminal device 102 can also be an M2M (machine to machine) device or telematic device that is configured for the automatic exchange of information with similar devices and/or system control centers. Such a device can be used, for example, for the remote monitoring, inspection and maintenance of machines, installations and other systems, and to this end, it can have monitoring sensors and control actuators that are adapted to the application purpose and that can be read out and controlled, for instance, by mobile telephony.

The mobile terminal device 102 comprises a terminal 103 that has a radio module 104 by which the mobile terminal device 102 can be connected to the mobile telecommunications network 101 via the radio access network. For this purpose, the radio module 104 has the requisite radio technology, for example, an antenna with associated peripherals, as well as a control unit for controlling the radio module 104 and for carrying out the data processing needed for the data exchange with the mobile telecommunications network 101 or with the radio access network. Aside from the radio module 104, the terminal 103 comprises additional components (not shown in the figure) such as, for example, one or more processes for controlling the terminal 103 and for executing additional programs employed by the user, one or more memory units for storing data and programs, input and output devices and, if applicable, additional hardware and software components for executing functions provided by the terminal 103.

The radio module 104 can be connected to an identification module 105 that makes data and processes available that are needed in order to for the mobile terminal device 102 to access the mobile telecommunications network 101. Among other things, data and processes made available by the identification module 105 are used for the subscriber identification and authentication in the mobile telecommunications network 101. The process of subscriber identification and authentication is normally carried out at the time of logging on to the mobile telecommunications network 101 and it comprises the identification of the identification module 105 on the basis of an identifier that is sent by the identification module 105 to the mobile telecommunications network 101, and it also comprises the authentication of the identification module on the basis of information that is computed in the identification module using specified algorithms and information. The identification module 105 has a special security architecture that prevents unauthorized access to security-relevant data and processes, especially to the above-mentioned data and processes used to access the mobile telecommunications network 101.

In one embodiment, the identification module 105 is a secured chip which is contained in a chip card that can be removably inserted into a card reader of the terminal 103. In this embodiment, which is used primarily for mobile terminal devices 102, which include mobile phones, smart phones or other computer devices employed by a user, the identification module 105 can be a SIM card or a USIM card that is used to access the mobile telecommunications network 101, which is configured as a GSM, UMTS or LTE (Long Term Evolution) network. By the same token, however, the identification module 105 can also be a chip that is permanently integrated into the mobile terminal device 101. In particular, the chip can be configured as a SIM chip or a USIM chip, that is to say, as a chip for subscriber identification and authentication in mobile telecommunication networks of the type described above. In another embodiment, the identification module can also be a secure software module that is implemented on a processor of the terminal 103 which can be, for example, the main processor.

The identification module 105 is registered in a mobile telecommunications network 101 that is also referred to as the home network of the identification module 105 or of the subscriber who is using the identification module 105. The home network can be the mobile telecommunications network 101 with whose operator the subscriber has entered into a mobile telephony contract. The operator of the home network or an agent acting on its behalf issues the identification module 105 to the subscriber after the identification module 105 has first been preconfigured in a secure process. Here, data specified by the operator of the home network for the identification and authentication of the identification module 105, the processes specified by the operator such as, for example, encryption algorithms used during the authentication, and other data specified by the operator are all installed in the identification module 105. The installation can be carried out in a uniform process, or else general data and processes specified by the operator can be installed ahead of time, for instance, at the time of production of the identification module 105, and in a subsequent procedure, a personalization in which subscriber-specific data is stored in the identification module 105 can be carried out, and this can be done, for example, in conjunction with the issuing of the identification module 105 to a subscriber.

After being issued, the identification modules 105 registered in the mobile telecommunications network 101 can be remotely accessed in order to make modifications. For example, data and processes or programs can be changed, augmented or deleted in the identification module 105. By remote access, such modifications can be made without the need for the identification modules to be modified at a service point of the cellular service provider or of another service provider, or to be reissued.

For the remote access, an OTA mechanism can be used in which an OTA server 106 sends messages to the identification module 105 that is registered in the mobile telecommunications network 101, and these messages can contain data for installation into the identification module and/or commands for changing data or for executing processes and programs in the identification module. The OTA server 106 can be arranged in the mobile telecommunications network 101, and can be operated, for instance, by the appertaining mobile telecommunications service provider, or else it can be operated by a reliable organization outside of the cellular network 101.

Cryptographic mechanisms are used in order to secure the remote access to the identification modules 105 and, above all, in order to protect against unauthorized access to the identification module 105. The messages sent by the OTA server 106, which will also be referred to below as OTA messages, are secured with a cryptographic key. The key is unambiguously associated with the addressed identification module 105 and stored under an identifier of the identification module 105 in a database 107 of the OTA server 106. In the identification module 105, the message is checked with an appropriate cryptographic key in order to verify the authenticity of the message.

The key used in the OTA server 106 for the encryption and the key used in the identification module 105 for the decryption, which are also referred to below as the OTA keys, can form a symmetrical key pair. By the same token, however, the use of asymmetrical pairs of keys can also be provided for. The OTA key used in the identification module 105 can have been stored in the identification module 105 during its above-mentioned preconfiguration. The identifier under which the cryptographic keys associated with the identification modules 105 are stored in the database 107 of the OTA server 106 can be a telephone number that is configured as an MSISDN, that is associated with the identification module 105 and that can also be utilized for addressing the OTA messages to the identification modules 105. In addition or as an alternative, the identifier can also comprise other identification codes associated with the identification module. If the telephone number is not contained in the identifier, then the telephone number is, in embodiments, stored in the OTA server 106 and it is used by the OTA server 106 to address messages to an identification module 105. As an alternative, the telephone number in this case is transferred to the OTA server 106 when the latter is instructed to transfer an OTA message to an identification module.

For security purposes, the data and/or commands that are contained in the messages sent to the identification module are, in embodiments, encrypted, at least partially encrypted, at least in the OTA server 106. The encrypted information is decrypted in the identification module 105 in order to be verified. The encryption protects the information against unauthorized access along the transmission route. In addition or as an alternative, it can be provided that the messages contain special authentication features such as, for example, digital signatures that are generated by the OTA key stored in the OTA server 106 and that are decrypted in the identification module 105 by the key stored there.

The OTA messages can be transmitted via a short message service made available in the mobile telecommunications network 101, whereby in one embodiment, this is the generally known SMS. By the same token, however, another message service can also be used. In the SMS, short messages are sent by an SMSC 108 of the mobile telecommunications network 101. In order to transmit OTA messages, the OTA server 106 has an SMS interface 109 via which it is connected to the SMSC 108. In order to transmit an OTA message to an identification module 105, the OTA server 106 transfers the secured content of the OTA message via the SMS interface 109, together with the identifier associated with the identification module 105. In response, the SMSC 108 then sends an OTA message configured as an SMS message to the mobile terminal device 101 using the telephone number associated with the identification module and, if applicable, contained in the identifier. This is fundamentally done in the same manner as the transmission of other SMS messages to the mobile terminal device 101. However, due to a special characteristic that is present, the terminal 103 forwards the OTA message to the identification module 105. This is, in embodiments, done transparently, that is to say, invisibly to the user of the mobile terminal device 102. In the identification module 105, the message is first authenticated after being received. After a successful verification, which especially comprises an authentication, the message is evaluated and received control commands are carried out.

With the OTA messages transmitted by SMS, in the mobile telecommunications network 101, especially data and messages with a small data volume are transmitted to the identification modules 105 that are registered in the mobile telecommunications network 101. The data volume, in embodiments, does not exceed the size of an SMS message so that the data does not have to be split into several OTA messages transmitted by SMS. Larger data volumes are made available in the mobile telecommunications network 101 by a data center 110 for transmission to the identification modules 105 that are registered in the mobile telecommunications network 101. The data center 110 can be operated by the operator of the OTA server 106 or by another service provider. As is shown in FIG. 1 merely by way of an example, the data center 110 can be operated in the network of the mobile telecommunications service provider, or else outside of this network. A modality for the secure transmission of data from the data center 110 to an identification module 105 is described below.

In order to be able to transmit data provided by the data center 110 in a secure manner to the identification module 105, security features of the OTA mechanism are employed, especially securing data by the cryptographic OTA key that is associated with the identification module 105 and that is stored in the OTA server 106. The securing procedure is, in embodiments, carried out in the OTA server 106 so that the OTA key of the identification module 105 does not leave the secure OTA server 106. In order to receive the data that is to be encrypted and to return the data that has been secured with the OTA key, the OTA server 106 provides an additional interface 111 that can be accessed by the external units. Data that is to be transmitted to the identification module 105 is transferred by the data center 110 to the OTA server 106 via this interface 111. This is done together with the identifier associated with the identification module 105. Then, on the basis of the received identifier, the OTA key of the identification module 105 is determined in the OTA server 106, and the data is secured with the OTA key. The secured data is then returned from the OTA server 106 to the data center 110 and can then be transmitted by the data center 110 to the identification module 105.

Fundamentally, any of the services provided by the mobile telecommunications network 101 for transmitting a larger data volume can be used for the transmission of the secured data. Since the data is secured by the OTA key of the identification module in the OTA server 106, a specially secured transmission channel is not needed. In one embodiment, it is provided that the data from the data center can be made available under an address that is associated with the data and that can be configured as a URL, for purposes of retrieval by the identification module via a data service provided by the mobile telecommunications network. The retrieval, that is to say, the downloading of the data onto the identification module, is controlled by an application executed in the identification module 105. Based on a command that initiates the retrieval, the application accesses the address of the data in a generally known manner and retrieves the data from the data center 110, in response to which the data is transmitted to the identification module 105.

The data is authenticated after it has been successfully verified with the key of the OTA key pair associated with the identification module 105 and contained in the identification module 105. After the data has been successfully authenticated, the data is further evaluated. Here, for example, parameters or programs contained in the data can be stored or installed in the identification module 105 and any control commands contained therein can be executed. If the data cannot be successfully verified, for example, because the decryption with the OTA key contained in the identification module 105 has failed, then the received data is discarded.

Examples of data services that can be used to retrieve the data from the data center 110 include GPRS (General Packet Radio Service), HSPA (High Speed Packet Access) or other data services. In order to use the data service to retrieve the data, the identification module 105 can access functions of the terminal 103 of the mobile terminal device 102 in order to log in to the data service and to use the data service. For this purpose, in one embodiment, the identification module 105 can make use of so-called proactive commands of a Card Application Toolkit (CAT), in case of a SIM or USIM card, especially of the SIM Application Toolkit or of the USIM Application Toolkit, which allow a chip card to access functions of the terminal 103. By the same token, the data service can be accessed in another manner as well, for example, by a suitable application for the access.

In one embodiment, the command for initiating the retrieval of the data from the data center 110 is transmitted to the identification module 105 via a secured OTA message. Upon being prompted by the data center 110, the OTA server 106 sends the OTA message to the identification module 105 in the above-mentioned manner via the short message service. In the identification module, the OTA message is authenticated in the conventional manner and, after it has been successfully authenticated, it is evaluated. During the evaluation, the command for retrieving the data is recognized and executed. The address under which the data is to be retrieved is transmitted to the identification module 105 with the command for initiating the retrieval, that is to say, in this embodiment, within the OTA message. For this purpose, the address of the data center 110 is transferred to the OTA server 106 when the data center 110 instructs the OTA server 106 to generate and send the OTA message for initiating the data retrieval. Moreover, the identifier associated with the identification module is transferred with the instructions for the data center 110 to send the OTA message from the data center 110 to the OTA server 106. On the basis of the identifier, the OTA key of the identification module is determined in the database 107 of the OTA server 106, and this key is used to secure the OTA message. The securing procedure here is carried out in the manner described above. In order to address the OTA message, the OTA server 106 uses the telephone number that is optionally contained in the identifier and associated with the identification module 105.

The transmission of the command and of the address by an OTA message has the advantage that a proven mechanism can be used to transmit commands to the identification module 105 and that the command is transmitted to the identification module 105 in a secure manner. Fundamentally, however, the command and the address can also be transmitted to the identification module 105 in other ways. In particular, it can also be provided that the retrieval of the data can be started manually by the user of the mobile terminal device 101, for example, in that the user starts the application for the retrieval via a menu provided in the mobile terminal device 102. Here, the user can also indicate the address for the retrieval of the data that the operator of the mobile telecommunications network 101 has made available to the user ahead of time in a suitable manner.

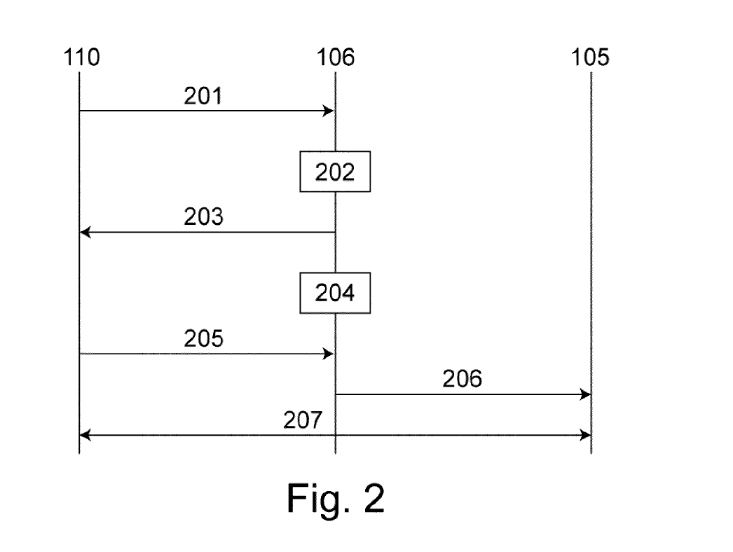

In an embodiment given by way of an example, using the above-mentioned mechanisms, data can thus be transmitted to an identification module, as will be explained below with reference to the schematic flow diagram depicted in FIG. 2.

First of all, the data that is to be transmitted to the identification module 105 is generated in the data center 110 or transmitted from an external source and made available in the data center 110. In Step 201, the data center 110 then transmits the data via the interface 111 to the OTA server 106, together with the identifier of the identification module 105. In Step 202, the OTA server 106 then secures the data in the manner described above by the OTA key of the identification module 105 that is determined in the database 107 of the OTA server 106 on the basis of the identifier transferred by the data center 110.

In Step 203, the secured data is then returned by the OTA server via the interface 111 to the data center 110. In Step 204, the data center then makes the secured data received from the OTA server 106 available for retrieval by the identification module 105. As described above, the data center 110 can generate an address for this purpose and can make the data available for retrieval under that address. After that, the data can be downloaded by the identification module 105.

In the embodiment shown, in Step 205, in order to start the retrieval of the data by the identification module 105, the data center 110 instructs the OTA server 106 to generate an OTA message with a command to initiate the retrieval and to send it to the identification module 105. The instruction can be transferred via the interface 111 to the OTA server 106 or via another interface that the OTA server 106 provides for this purpose. Together with the instruction, the address is transferred under which the data can be retrieved, as well as the identifier associated with the identification module. The address is inserted into the OTA message by the OTA server 106, and the identifier is used for determining the OTA key of the identification module 105 in the database 107, said OTA key having been employed to secure the OTA message. In Step 206, the OTA message is then transmitted from the OTA server 106 to the identification module 105. The transmission is made by the short message service in the above-mentioned manner via the SMSC, which is not shown in FIG. 2.

In Step 207, after the OTA message has been received in the identification module 105 and successfully verified and, in particular, authenticated, it is evaluated, and an application of the identification module 105 controls the transmission of the data from the data center 110 to the identification module 105. For this purpose, in the manner described above, the application of the identification module 105 uses the terminal 103 of the mobile terminal device 102 to access a data service provided on the mobile telecommunications network 101 and retrieves the data from the data center 110 via the data service under the address indicated in the OTA message. The retrieved data is then verified in the identification module 105 with the OTA key of the identification module 105 and, after having been successfully verified, it is used in the intended manner. This can mean, for instance, that any control commands contained in the data are executed in the identification module 105 and contained parameters or programs are stored or installed in the identification module 105. If the downloaded data cannot be successfully authenticated, it is discarded.

Although the technique described herein has been described in detail in the drawings and in the presentation given above, the presentations are merely illustrative and provided by way of example, and should not be construed in a limiting manner. In particular, the technique described herein is not limited to the explained embodiments. The person skilled in the art can glean additional variants of the technique described herein and their execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the techniques described herein.

1-13. (canceled)

14. A method for securely transmitting data to an identification module in a mobile terminal device connected to a mobile telecommunications network, comprising:
storing security information for a plurality of identification modules in a database of an over-the-air (OTA) server, wherein the OTA server comprises a first interface for transmitting secured information, especially OTA messages, to the identification modules, and wherein, in order to be secured in the OTA server, the data is transferred by a data center to the OTA server via a second interface, wherein the data is secured in the OTA server by the security information stored in the database;
transferring the secured data is transferred via the second interface of the OTA server to the data center that is connected to the OTA server; and
transmitting the transferred data is to the identification module from the data center.

15. The method according to claim 14, wherein the security information comprises cryptographic keys, and the data is secured by an at least partial encryption with a cryptographic key.

16. The method according to claim 14, wherein the security information is unambiguously associated with the identification modules, and wherein, in order to secure the data, security information is used that is specified by the data center.

17. The method according claim 16, wherein, in order to specify the security information to be used, the data center transfers to the OTA server an identifier associated with an identification module, wherein the security information is stored in the database along with an indication of the identifier.

18. The method according to claim 14, wherein the secured date is retrieved from the data center by the mobile terminal device so that it can be transmitted to the identification module.

19. The method according to claim 18, wherein the retrieval of the secured data from the data center by the mobile terminal device is controlled by the identification module.

20. The method according to claim 18, wherein the secured data is retrieved from the data center in response to a message being received in the mobile terminal device, especially in the identification module.

21. The method according to claim 20, wherein the secured data is made available for retrieval under an address, especially a URL, and wherein the address is contained in the message.

22. The method according to claim 20, wherein the message is sent by the OTA server and it is an OTA message.

23. The method according to claim 22, wherein the data center instructs the OTA server to transmit the OTA message.

24. The method according to claim 14, wherein the identification module is a secure module in the mobile terminal device that provides information and/or processes for identifying and/or authenticated the identification module in the mobile telecommunications network.

25. A system for transmitting data to an identification module in a mobile terminal device that can be connected to a mobile telecommunications network, comprising:
an over-the-air (OTA) server to secure data;
a database of the OTA server having security information for a plurality of identification modules;
a first interface of the OTA server to transmit secured information, especially OTA messages, to the identification modules; and
a data center to transfer data that is to be transmitted to the identification module via a second interface of the OTA server, and wherein the OTA server is to transfer the secure data via the second interface of the OTA server so as to make it available for the transmission from the data center to the identification module.

26. The system according to claim 25, wherein the security information comprises cryptographic keys, and the data is secured by an at least partial encryption with a cryptographic key.

27. The system according to claim 25, wherein the security information is unambiguously associated with the identification modules, and wherein, in order to secure the data, security information is used that is specified by the data center.

28. The system according claim 27, wherein, in order to specify the security information to be used, the data center transfers to the OTA server an identifier associated with an identification module, wherein the security information is stored in the database along with an indication of the identifier.

29. The system according to claim 25, wherein the secured date is retrieved from the data center by the mobile terminal device so that it can be transmitted to the identification module.

30. The system according to claim 29, wherein the retrieval of the secured data from the data center by the mobile terminal device is controlled by the identification module.

31. The system according to claim 29, wherein the secured data is retrieved from the data center in response to a message being received in the mobile terminal device, especially in the identification module, and wherein the secured data is made available for retrieval under an address, especially a URL, and wherein the address is contained in the message.

32. The system according to claim 31, wherein the message is sent by the OTA server and it is an OTA message, and wherein the data center instructs the OTA server to transmit the OTA message.

33. The system according to claim 25, wherein the identification module is a secure module in the mobile terminal device that provides information and/or processes for identifying and/or authenticated the identification module in the mobile telecommunications network.
